(19) United States
(12) Patent Application Publication
(10) Pub. No.: US 2013/0109829 A1
(43) Pub. Date: May 2, 2013

(54) RESIN COMPOSITION CONTAINING AROMATIC POLYISOCYANATE COMPOUND, BISPHENOL EPOXY RESIN AND IMIDAZOLE COMPOUND, AND HIGHLY THERMO-RESISTANT ISOCYANURATED CURED MATERIAL FORMED FROM THE SAME

(71) Applicant: NIPPON STEEL CHEMICAL CO., LTD., TOKYO (JP)

(72) Inventor: NAOKI YOKOYAMA, CHIBA (JP)

(73) Assignee: NIPPON STEEL CHEMICAL CO., LTD., TOKYO (JP)

(21) Appl. No.: 13/659,894

(22) Filed: Oct. 24, 2012

(30) Foreign Application Priority Data
Oct. 28, 2011 (JP) 2011-237019

(51) Int. Cl. C08G 59/02

(52) U.S. Cl. 528/59

(57) ABSTRACT

A liquid-state resin composition containing an aromatic polyisocyanate compound (A), a bisphenol epoxy resin (B) and an imidazole compound (C) is described, wherein the molar ratio of isocyanate groups to epoxy groups is 2 or more and preferably 2 to 15, and the amount of (C) relative to the total weight of (A), (B) and (C) is in the range of 0.2 wt % to 0.8 wt %. By stir-mixing (B) and (C), adding (A), stir-mixing again, and vacuum-degassing the resulting resin composition, a highly thermo-resistant isocyanurated cured material with a glass transition temperature of 250° C. or higher can be obtained by heat-curing the resin composition, without forming a gelated substance or bubbles.

### CROSS-REFERENCE TO RELATED APPLICATION

This application claims the priority benefit of Japan application serial no. 2011-237019 filed on Oct. 28, 2011. The entirety of the above-mentioned patent application is hereby incorporated by reference herein and made a part of this specification.

### BACKGROUND OF THE INVENTION

1. Field of Invention

This invention relates to a resin composition containing an aromatic polyisocyanate compound, a bisphenol epoxy resin and an imidazole compound, and also to a highly thermo-resistant isocyanurated cured material formed from the same.

2. Description of Related Art

A highly thermo-resistant cured material having isocyanurate ring structures can be obtained by heat-curing a liquid-state resin composition containing a polyisocyanate compound, an epoxy resin, and an imidazole compound as a catalyst, as described in Patent Document 1. Moreover, Patent Document 2 exemplified a liquid-state resin composition containing polymeric 4,4′-diphenylmethanediisocyanate (sometimes called “polymeric MDI” hereafter) as a polyisocyanate compound, a bisphenol-A epoxy resin as an epoxy resin, and 2-ethyl-4-methylimidazole as an imidazole compound. Further, claim 1 of Patent Document 3 described a resin composition in which the molar ratio (referred to as “I/E ratio”, hereinafter) of the isocyanate groups (I) of the polyisocyanate compound to the epoxy groups (E) of the epoxy resin is 2 or more.

However, when the above liquid-state resin composition with a high isocyanate content and an TIE ratio of 2 or more is heat-cured, the moisture contained in the resin composition reacts with isocyanate to form carbon dioxide so that bubbles exist in the cured material. Moreover, when the polyisocyanate compound, the epoxy resin and the imidazole compound are mixed to prepare a resin composition, gelated substance is easily formed.

### [Prior-Art Documents]

### [Patent Documents]

Patent Document 1: Japanese Patent Publication No. Sho 51-111898

Patent Document 2: Japanese Patent Publication No. Sho 60-69121

Patent Document 3: Japanese Patent Publication No. Sho 62-167315

### [Non-Patent Document]

Non-Patent Document 1: Koyama Tom, and Narahara Toshikazu; Journal of the Chemical Society of Japan, 1986, (12), 1758 (1986).

### SUMMARY OF THE INVENTION

After studying for solutions of the above problems, the Inventor discovered that a highly thermo-resistant isocyanurated cured material having a glass transition temperature of 250° C. or higher can be obtained without forming gelated substance or containing bubbles therein by the followings. A resin composition containing an aromatic polyisocyanate compound (A), a bisphenol epoxy resin (B) and an imidazole compound (C) is provided, wherein the I/E ratio is 2 or more and preferably 2 to 15, and the amount of (C) relative to the total weight of (A), (B) and (C) is in the range of 0.2-0.8 wt %. By stir-mixing (B) and (C), adding (A), stir-mixing again and vacuum-degassing the mixture to prepare the resin composition and then heat-curing the same, the target isocyanurated cured material is obtained. This invention is based on the above discovery.

Specifically, this invention relates to the following aspects 1-5: The aspect 1 is a resin composition with a liquid state at room temperature, which includes: an aromatic polyisocyanate compound (A), a bisphenol epoxy resin (B) and an imidazole compound (C), wherein the molar ratio (UE ratio) of the isocyanate groups (I) of the aromatic polyisocyanate compound (A) to the epoxy groups (E) of the bisphenol epoxy resin (B) is 2 or more, and the amount of the imidazole compound (C) relative to the total weight of (A), (B) and (C) is within the range of 0.2-0.8 wt %.

The aspect 2 is the resin composition of the aspect 1 wherein the aromatic polyisocyanate compound (A) includes polymeric 4,4′-diphenylmethanediisocyanate, the bisphenol epoxy resin (B) includes liquid-state bisphenol-A diglycidyl ether, and the imidazole compound (C) includes 2-ethyl-4-methylimidazole.

The aspect 3 is a method for preparing the resin composition of the aspect 1 or 2, which includes: stir-mixing the bisphenol epoxy resin (B) and the imidazole compound (C), adding the aromatic polyisocyanate compound (A) and stir-mixing it with (B) and (C), and then performing a vacuum-degassing step.

The aspect 4 is a method of the aspect 3 wherein the bisphenol epoxy resin (B) and the imidazole compound (C) are stir-mixed at room temperature, the aromatic polyisocyanate compound (A) is added and stir-mixed with (B) and (C) at room temperature, and the vacuum-degassing step is performed at room temperature for 3.5 hours or less.

The aspect 5 is an isocyanurated cured material that is formed by heat-curing the resin composition of the aspect 1 or 2 and has a glass transition temperature (Tg) of 250° C. or higher.

### Effects of the Invention

By using the resin composition and its preparation method of this invention, gelated substance is not formed in the preparation of the resin composition or in the vacuum degassing, and the obtained cured material contains no bubble. Thus, it is possible to provide a stable and high-quality isocyanurated cured material as a highly thermo-resistant resin to various applications requiring a high Tg of 200° C. or higher and preferably 230° C. or higher, such as composite materials, semiconductor encapsulants, printed circuit boards, adhesives, coating materials and so on.

In order to make the aforementioned and other objects, features and advantages of this invention comprehensible, some embodiments are described in detail below.

### DESCRIPTION OF EMBODIMENTS

In this invention, formation of a gelated substance is prevented by stir-mixing the imidazole compound (C) (abbreviated as “(C)” hereafter) and the bisphenol epoxy resin (B) (abbreviated as “(B)” hereafter) at room temperature, and then adding the aromatic polyisocyanate compound (A) (abbreviated as “(A)” hereafter) and stir-mixing it with (B) and (C) at room temperature. The mechanism of such method is not clear. Nevertheless, Non-Patent Document 1 has described that the adduct of (C) to (B) (referred as “(C+B) adduct” hereafter) formed by mixing (C) and (B) functions as the catalyst of the isocyanurate cyclization reaction due to trimerization of the isocyanate groups, and the reaction intermediate of the oxazolidone cyclization reaction due to the reaction of isocyanate groups and epoxy groups. Accordingly, the Inventor considered that in the case where (A), (B) and (C) are mixed simultaneously or (C) is mixed after (A) and (B) are mixed, the (C+B) adduct as the catalyst or reaction intermediate is formed around the mixed (C) in a localized and highly concentrated manner in the resin composition, so that the isocyanurate cyclization reaction or the oxazolidone cyclization reaction also occurs around (C) in a localized and highly concentrated manner, which is supposed to relate to the formation of the gelated substance. On the other hand, by adding (A) after (C) and (B) are stir-mixed and then stir-mixing them again, it is supposed that localization of the (C+B) adduct could be inhibited and formation of the gelated substance could be prevented.

Moreover, the compound (C) used in this invention not only functions as an isocyanuration catalyst in the thermal curing in the form of the (C+B) adduct, but also as the catalyst of the reaction of isocyanate with the moisture that forms carbon dioxide. For this reason, the amount of (C) relative to the total weight of (A), (B) and (C) is within the range of 0.2-0.8 wt % and preferably in the range of 0.3-0.7 wt %, so that the moisture contained in the resin composition completely reacts with isocyanate in the vacuum degassing of the liquid-state resin composition containing (A), (B) and (C) to form carbon dioxide, which will all be discharged out of the system. Thereby, in the thermal curing as the next step, carbon oxide is not formed and no bubble exists in the cured material. When the proportion of (C) is less than 0.2 wt %, the reaction of the moisture with isocyanate is incomplete in the vacuum-degassing step, so that carbon oxide is formed in the thermal curing and bubbles exists in the cured material. On the contrary, when the proportion of (C) exceeds 0.8 wt %, the isocyanuration reaction or oxazolidone cyclization reaction occurs in the vacuum degassing, so that a gelated substance or a skinning film is formed.

In this invention, the vacuum degassing is for discharging and removing the air incorporated in the preparation of the resin composition, and the carbon dioxide formed by the reaction of moisture and isocyanate. The incorporated air is quickly discharged and removed directly after the start of the vacuum degassing, but the reaction of isocyanate and the moisture contained in the resin composition takes certain time.

However, if the vacuum degassing is conducted overly long, the curing reaction also occurs to form a gelated substance or a skinning film. Hence, the duration of vacuum degassing is properly 3.5 hours or shorter, preferably 2.0 hours or shorter.

When the liquid-state resin composition containing (A), (B) and (C) used in this invention is heat-cured, the isocyanate groups in (A) are trimerized due to the catalytic effect of the (B+C) adduct, so that a thermally cured material having highly thermo-resistant isocyanurate-cyclized structures is formed. On the other hand, a thermally cured material having oxazolidone-cyclized structures with a lower thermal resistance than isocyanurate-cyclized structures is also formed from the reaction of the isocyanate groups and the epoxy groups. Specifically, when the I/E ratio is larger, i.e., when the proportion of (A) is larger, the isocyanurate-cyclized structure is formed more than the oxazolidone-cyclized structure. On the contrary, when the I/E ratio is smaller, i.e., when the proportion of (A) is smaller, the isocyanurate-cyclized structure is formed less than the oxazolidone-cyclized structure, and the Tg of the cured material is lowered.

Accordingly, when the I/E ratio is less than 2, the Tg of the cured material is below 250° C., and the required thermal resistance is difficult to obtain. On the other hand, when the I/E ratio is overly large, the cured material is more fragile and easily has cracks, and is anticipated to be difficult in maintaining the target shape. Hence, the I/E ratio is preferably 2 to 30, more preferably 2 to 15.

The polyisocyanate compound (A) used in this invention is preferably one having a liquid state at room temperature, such as polymeric MDI, polyol-modified 4,4′ -diphenylmethanediisocyanate, or polyol-modified tolylenediisocyanate, etc.

The bisphenol epoxy resin (B) is also preferably one having a liquid state at room temperature, such as bisphenol-A diglycidyl ether (called “BADGE” hereafter), bisphenol-F diglycidyl ether, or bisphenol-S diglycidyl ether, etc.

The imidazole compound (C) used as a catalyst in this invention is also preferably one having a liquid state at room temperature, such as 2-ethyl-4-methyl-imidazole (called “2E4MZ” hereafter), 1,2-dimethylimidazole, 1-benzyl-2-phenyl-imidazole, or 1-cyanoethyl-2-ethyl-4-methylimidazole, etc.

### EXAMPLES

This invention is further described specifically with the examples below. The evaluation methods of the properties mentioned in the examples are as follows.

(1) Formation of a gelated substance or a skinning film in the resin composition was observed by eyes when the resin composition was prepared and vacuum-degassed.

(2) Formation of isocyanurate ring structures of the cured material was identified by FT-IR measurement, and identification of the absorption peak at 1710 cm⁻¹ due to the stretching vibration of the carbonyl groups of the isocyanurate.

(3) The glass transition temperature (Tg, ° C.) of the cured material was measured as the peak temperature of the temperature dispersion loss tangent curve of the cured material obtained by a dynamic viscoelasticity measurement (referred to as “DMA” hereafter) conducted at a frequency of 10 Hz and a temperature raise rate of 2° C./min, or as the rise-shoulder temperature of the same curve when the peak was not clear. Moreover, the turning-point temperature of the linear expansion curve obtained by the later described TMA measurement was taken as the reference Tg.

(4) The linear expansion coefficient (ppm) of the cured material was measured by a TMA tool at a temperature raise rate of 10° C./min, a measurement temperature range of 20-280° C. and a probe compression load of 100 mN. In the second scan of the measurement, the linear expansion coefficient in the range of 50-100° C. and that in of the range of 230-250° C. were recorded as al and a2, respectively.

(5) The temperatures (° C.) at 1 wt %, 5 wt % and 10 wt % loss of the heating weight-loss test, which are respectively referred to as “Td1”, “Td5” and “Td10” hereafter, were measured by a TG-DTA apparatus at a temperature raise rate of 10° C./min under an air flow, and were each determined, based on the obtained heating weight-variation curve of the cured material, as the temperature at which 1%, 5% or 10% of weight was lost relative to the weight at 150° C. that was taken as a baseline.

### Example 1

0.18 g of 2-ethyl-4-methylimidazole as an imidazole compound was placed in a disposable cup of 300 ml, 6.00 g of bisphenol-A diglycidyl ether (YD128™, produced by Nippon Steel Chemical Co., Ltd.) having an epoxy equivalent of 186 g/eq was then added as an epoxy resin, a stainless stirring bar was used to stir-mix them, and the mixture is placed still for 15 minutes. Then, 53.82 g of polymeric MDI (Cosmonate™ M-50, produced by Mitsui Chemicals, Inc.) having an isocyanate equivalent of 137 g/eq was added as a polyisocyanate compound and stir-mixed with the above mixture using the stainless stirring bar again, thus preparing a liquid-state resin composition of 60 g that had an UE ratio of 12.5 and a proportion of imidazole catalyst of 0.3 wt %. No gelated substance was formed in the stir-mixing. The liquid-state resin composition was then vacuum-degassed in a vacuum desiccator at room temperature for 3 hours. No gelated substance was formed in the vacuum degassing, either. The vacuum-degassed liquid-state resin composition was then injected in a die having six spaces of 140×10×4 mm³ (length×width×thickness), and was thermally cured in a hot-air oven at 100° C. for 2 hours, 150° C. for 2 hours and then 200° C. for 10 hours. The properties of the obtained heat-cured material are listed in Table 1. No bubble was identified in the thermally cured material by visual observation, and the formation of isocyanurate ring structures was identified by the presence of the 1710 cm⁻¹ absorption in the FT-IR measurement. The Tg was determined, by DMA measurement, to be 277° C. from the shoulder temperature of the rise segment of the tan δ curve, because no tan δ peak was shown. Such Tg was much higher than 250° C. as the criterion of thermo-resistance. No Tg was obtained from the TMA measurement, because no turning point was present in the linear expansion curve in the temperature range below 280° C. Therefore, it was clear that the Tg was well above 250° C. Moreover, α1 and α2 were 61 ppm and 77 ppm, respectively, which meant that the linear expansion ratio was also good or very low even in the high-temperature range of 230-250° C. The Td1, Td5 and Td10 temperatures measured by TG-DTA were 291° C., 350° C. and 377° C., respectively, which are all high temperatures. According to the above results, the obtained isocyanurated thermally cured material was highly thermo-resistant.

### Example 2 & Example 3

Resin compositions were prepared with the same method and conditions as in Example 1, except that the proportions of the imidazole catalyst were changed to 0.5 wt % and 0.7 wt %, respectively, as shown in Table 1. As in the case of Example 1, no gelated substance was formed. Next, vacuum degassing, die injection and thermal curing were performed with the same methods in Example 1 to obtain cured materials. No gelated substance or skinning film was formed in the vacuum degassing, either. The properties of the obtained cured materials are listed in Table 1. As in the case of Example 1, the cured material contained no bubble, and the high Tg above 250° C., the small α2 value and the high Td1, Td5 and Td10 indicated a good thermal resistance.

### Example 4

A resin composition was prepared in the same conditions as in Example 2, except that the duration of the vacuum degassing was changed to 1 hour as shown in Table 1. No gelated substance was formed in the preparation of the resin composition. Then, vacuum degassing, die injection and thermal curing were performed in the same conditions mentioned above to obtain a cured material. No gelated substance or skinning film was formed in the vacuum degassing, either. The properties of the obtained cured material are listed in Table 1. The cured material contained no bubble, and the high Tg above 250° C., the small α2 value and the high Td1, Td5 and Td10 indicated a good thermal resistance.

### Examples 5-7

Resin compositions were prepared in the same conditions as in Example 2, except that the proportions of the polyisocyanate compound and the epoxy resin were changed as shown in Table 1 to change the I/E ratio to 5.6, 3.2 or 2.1. No gelated substance was formed in the preparation of the resin composition. Then, vacuum degassing, die injection and thermal curing were performed in the same conditions mentioned above to obtain a cured material. No gelated substance was formed in the vacuum degassing, either. The properties of the obtained cured materials are listed in Table 1. As shown in Table 1, the cured material contained no bubble, and the high Tg above 250° C., the small α2 value and the high Td1, Td5 and Td10 indicated a good thermal resistance.

### Comparative Example 1

A cured material was obtained with the same method and conditions as in Example 1, except that the proportion of the imidazole catalyst in the resin composition was changed to 0.1 wt %. However, the cured material contained a lot of bubbles and was substandard. Hence, no property evaluation was performed on the cured material.

### Comparative Example 2

The operations of Example 1 until the vacuum degassing were conducted with the same method and conditions, except that the proportion of the imidazole catalyst in the resin composition was changed to 1.0 wt %. The result was substandard because a skinning film was formed, which was considered to be caused by the gelation in the vacuum degassing. Hence, thermal curing and property evaluation were not conducted.

### Comparative Example 3

A resin composition with the same composition ratio of Example 2 was prepared, except that the imidazole compound was mixed after the polyisocyanate compound and the epoxy resin were mixed. However, the prepared resin composition was substandard because a large amount of insoluble gelated substance was formed therein. Hence, subsequent thermal curing and property evaluation were not conducted.

### Comparative Example 4

A resin compositions was obtained with the same method and conditions as in Example 1, except that the composition ratio of the resin composition was changed as shown in Table 2 to change the UE ratio to 1.4. The properties of the cured material were shown in Table 2. The thermal resistance of the cured material was insufficient because the Tg of 244° C. was below 250° C., which is the criterion of thermal resistance.

### Comparative Example 5

The operations of Example 3 until the vacuum degassing were conducted with the same method and conditions, except that the duration of the vacuum degassing of the resin composition was changed to 4 hours as shown in Table 2. The result was substandard because a skinning film was formed, which was considered to be caused by the gelation in the vacuum degassing. Hence, the subsequent operations were not conducted.

TABLE 1

| | | | ^{a}Ex. 1 | Ex. 2 | Ex. 3 | Ex. 4 | Ex. 5 | Ex. 6 | Ex. 7 |
|---|---|---|---|---|---|---|---|---|---|
| Composition ratio | Polyisocyanate | Polymeric MDI | 53.82 | 53.70 | 53.58 | 53.82 | 47.7 | 41.7 | 35.7 |
| and properties of the | compound | | (89.7) | (89.5) | (89.3) | (89.7) | (79.5) | (69.5) | (59.5) |
| resin composition | Epoxy resin | Bisphenol-A | 6.00 | 6.00 | 6.00 | 6.00 | 12.0 | 18.0 | 24.0 |
| | | diglycidyl ether | (10.0) | (10.0) | (10.0) | (10.0) | (20.0) | (30.0) | (40.0) |
| | Imidazole catalyst | 2-ethyl-4-methyl- | 0.18 | 0.30 | 0.42 | 0.18 | 0.3 | 0.3 | 0.3 |
| | | imidazole | (0.3) | (0.5) | (0.7) | (0.3) | (0.5) | (0.5) | (0.5) |
| | Total weight/g (wt %) | | 60 | 60 | 60 | 60 | 60 | 60 | 60 |
| | | | (100) | (100) | (100) | (100) | (100) | (100) | (100) |
| | I/E ratio | | 12.5 | 12.5 | 12.5 | 12.5 | 5.6 | 3.2 | 2.1 |
| | Proportion of the imidazole | | 0.3 | 0.5 | 0.7 | 0.5 | 0.5 | 0.5 | 0.5 |
| | catalyst/wt % | | | | | | | | |
| | Formation of gelated substance | | No | No | No | No | No | No | No |
| | (observed by eyes) | | | | | | | | |
| | Duration of the vacuum | | 3.0 | 3.0 | 3.0 | 1.0 | 3.0 | 3.0 | 3.0 |
| | degassing/hour | | | | | | | | |
| | Conditions of the heat curing | | 100° C. for 2 hours, 150° C. for 2 hours, | | | | | | |
| | | | and then 200° C. for 10 hours | | | | | | |
| Properties of the | Eye-observation | Presence of bubbles | No | No | No | No | No | No | No |
| cured material | FT-IR | Presence of isocyanurate | Yes | Yes | Yes | Yes | Yes | Yes | Yes |
| | | (ν═_{C}═_{O} at 1710 cm⁻¹) | | | | | | | |
| | DMA | Tg (° C.) | *277 | *280 | *275 | *283 | *265 | *260 | *255 |
| | | *Rise shoulder | | | | | | | |
| | | temperature of tanδ (when | | | | | | | |
| | | no tanδ peak was seen) | | | | | | | |
| | | E' (GPa) at 40° C. | 5.7 | 5.6 | 5.8 | 6.0 | 2.9 | 2.7 | 3.1 |
| | | E' (GPa) at 250° C. | 4.0 | 4.3 | 4.8 | 5.2 | 2.3 | 2.2 | 1.8 |
| | TMA | Tg (° C.) | NA | NA | NA | NA | NA | 270 | 259 |
| | | | (no | (no | (no | (no | (no | | |
| | | | turning | turning | turning | turning | turning | | |
| | | | point) | point) | point) | point) | point) | | |
| | | α1 (ppm) at 50-100° C. | 61 | 56 | 60 | 62 | 61 | 58 | 59 |
| | | α2 (ppm) at 230-250° C. | 77 | 70 | 80 | 75 | 60 | 80 | 84 |
| | TG-DTA | Td1 (° C.) | 291 | 293 | 299 | 301 | 296 | 298 | 278 |
| | | Td5 (° C.) | 350 | 354 | 350 | 260 | 347 | 339 | 325 |
| | | Td10 (° C.) | 377 | 380 | 369 | 381 | 366 | 356 | 346 |

^{a}Ex. = Example

TABLE 2

| | | | ^{a}CEx. 1 | CEx. 2 | CEx. 3 | CEx. 4 | CEx. 5 |
|---|---|---|---|---|---|---|---|
| Composition ratio | Polyisocyanate | Polymeric MDI | 53.94 | 53.40 | 53.70 | 29.70 | 53.58 |
| and properties of the | compound | | (89.9) | (89.0) | (89.5) | (49.5) | (89.3) |
| resin composition | Epoxy resin | Bisphenol-A | 6.00 (10.0) | 6.00 (10.0) | 6.00 (10.0) | 30.00 | 6.00 (10.0) |
| | | diglycidyl ether | | | | (50.0) | |
| | Imidazole catalyst | 2-ethyl-4-methyl- | 0.06 (0.1) | 0.60 (1.0) | 0.30 (0.5) | 0.30 (0.5) | 0.42 (0.7) |
| | | imidazole | | | | | |
| | Total weight/g (wt %) | | 60 (100) | 60 (100) | 60 (100) | 60 (100) | 60 (100) |
| | I/E ratio | | 12.5 | 12.5 | 12.5 | 1.4 | 12.5 |
| | Proportion of the imidazole | | 0.1 | 1.0 | 0.5 | 0.5 | 0.7 |
| | catalyst/wt % | | | | | | |
| | Formation of gelated | | No | Yes | Yes | No | Yes |
| | substance (observed by eyes) | | | | | | |
| | Duration of the vacuum | | 3.0 | 3.0 | Not | 3.0 | 4.0 |
| | degassing/hour | | | | conducted | | |
| | Conditions of the heat curing | | | 100° C. for 2 hours, 150° C. for 2 hours, | | | |
| | | | | and then 200° C. for 10 hours | | | |
| Properties of the | Eye-observation | Presence of bubbles | Yes | Not | Not | No | Not |
| cured material | | | | conducted | conducted | | conducted |
| | FT-IR | Presence of isocyanurate | Not | Not | Not | Yes | |
| | | (ν═_{C}═_{O} at 1710 cm⁻¹) | conducted | conducted | conducted | | |
| | DMA | Tg (° C.) | | | | 244 | |
| | | E' (GPa) at 40° C. | | | | 5.4 | |
| | | E' (GPa) at 250° C. | | | | 0.214 | |
| | TMA | Tg (° C.) | | | | 220 | Not |
| | | αl (ppm) at 50-100° C. | | | | 61 | conducted |
| | | α2 (ppm) at 230-250° C. | | | | 132 | |
| | TG-DTA | Td1 (° C.) | | | | 250 | |
| | | Td5 (° C.) | | | | 309 | |
| | | Td10 (° C.) | | | | 334 | |

^{a}CEx. = Comparative Example

### [Utility in the Industry]

As mentioned above, by using the resin composition and its preparation method of this invention, a gelated substance or a skinning film is not formed in the preparation or the vacuum-degassing of the resin composition, and the obtained cured material contains no bubble. Hence, the cured material is expected to be used as a highly thermo-resistant resin in various applications requiring a high glass transition temperature of 200° C. or higher and preferably 230° C. or higher, such as composite materials, semiconductor encapsulants, printed circuit boards, adhesives, coating materials and so on.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A resin composition having a liquid state at a room temperature, comprising: an aromatic polyisocyanate compound (A), a bisphenol epoxy resin (B), and an imidazole compound (C), wherein a molar ratio (I/E ratio) of isocyanate groups (I) of the aromatic polyisocyanate compound (A) to epoxy groups (E) of the bisphenol epoxy resin (B) is 2 or more, and an amount of the imidazole compound (C) relative to a total weight of the aromatic polyisocyanate compound (A), the bisphenol epoxy resin (B) and the imidazole compound (C) is within a range of 0.2 wt % to 0.8 wt %.

2. The resin composition of claim 1, wherein the aromatic polyisocyanate compound (A) comprises polymeric 4,4′-diphenylmethanediisocyanate, the bisphenol epoxy resin (B) comprises liquid-state bisphenol-A diglycidyl ether, and the imidazole compound (C) comprises 2-ethyl-4-methylimidazole.

3. A method for preparing the resin composition of claim 1, comprising:
stir-mixing the bisphenol epoxy resin (B) and the imidazole compound (C);
adding the aromatic polyisocyanate compound (A) and stir-mixing it with the bisphenol epoxy resin (B) and the imidazole compound (C); and
performing a vacuum-degassing step.

4. The method of claim 3, wherein
the step of stir-mixing the bisphenol epoxy resin (B) and the imidazole compound (C) is performed at room temperature,
the step of adding the aromatic polyisocyanate compound (A) and stir-mixing it with the bisphenol epoxy resin (B) and the imidazole compound (C) is performed at a room temperature, and
the vacuum-degassing step is performed at the room temperature for 3.5 hours or less.

5. A method for preparing the resin composition of claim 2, comprising:
stir-mixing the bisphenol epoxy resin (B) and the imidazole compound (C);
adding the aromatic polyisocyanate compound (A) and stir-mixing it with the bisphenol epoxy resin (B) and the imidazole compound (C); and
performing a vacuum-degassing step.

6. The method of claim 5, wherein
the step of stir-mixing the bisphenol epoxy resin (B) and the imidazole compound (C) is performed at room temperature,
the step of adding the aromatic polyisocyanate compound (A) and stir-mixing it with the bisphenol epoxy resin (B) and the imidazole compound (C) is performed at room temperature, and
the vacuum-degassing step is performed at room temperature for 3.5 hours or less.

7. An isocyanurated cured material, formed by heat-curing the resin composition of claim 1, and having a glass transition temperature of 250° C. or higher.

8. An isocyanurated cured material, formed by heat-curing the resin composition of claim 2, and having a glass transition temperature of 250° C. or higher.
